(19) United States
(12) Patent Application Publication
(10) Pub. No.: US 2012/0237852 A1
(43) Pub. Date: Sep. 20, 2012

(54) SOLID OXIDE FUEL CELL

(76) Inventors: Hyun Soh, Yongin-si (KR); Duk-Hyoung Yoon, Yongin-si (KR); Tae-Ho Kwon, Yongin-si (KR)

(21) Appl. No.: 13/239,257

(22) Filed: Sep. 21, 2011

Related U.S. Application Data
(60) Provisional application No. 61/452,850, filed on Mar. 15, 2011.

(51) Int. Cl. H01M 8/04; H01M 4/86

(52) U.S. Cl. 429/512

(57) ABSTRACT

A solid oxide fuel cell includes: a first electrode having a first side and a second side substantially parallel to the first side; a plurality of walls partitioning an interior of the first electrode into a plurality of flow channels extending through the first electrode, wherein a first wall of the walls extends from the first side to a center portion of the second side and a second wall of the walls extends from the first side to the center portion of the second side; a current collector adjacent a center portion of the first side or the center portion of the second side; a second electrode partially surrounding the first electrode; and an electrolyte between the first electrode and the second electrode.

### CROSS-REFERENCE TO RELATED APPLICATIONS

This application claims the benefit of U.S. Provisional Application No. 61/452,850, filed on Mar. 15, 2011, in the United States Patent and Trademark Office, the disclosure of which is incorporated herein in its entirety by reference.

### BACKGROUND

1. Field

An aspect of the present invention relates to a solid oxide fuel cell (SOFC).

2. Description of the Related Art

Fuel cells may be classified into various kinds of fuel cells according to the kind of electrolyte. Because the fuel cells have various power ranges, usages and the like, a suitable fuel cell can be selected according to its intended use. In solid oxide fuel cells (SOFCs), it is relatively easy to control the position of an electrolyte, and there is no risk of exhausting the electrolyte because of the fixed position of the electrolyte. Further, because the SOFCs are strong against corrosion, the lifetime of the SOFCs is extended. For these reasons, the SOFCs have come into the spotlight as fuel cells for distributed generation, commerce and domestic use.

Fuel cells may be classified into a flat planar fuel cell, a flat tubular fuel cell, a tubular fuel cell, and the like according to the shape of a unit cell. Recently, research has been actively conducted to develop a free-standing fuel cell using an electrolyte as a support and a flat tubular fuel cell using an anode as a support.

### SUMMARY

Embodiments of the present invention are directed to a solid oxide fuel cell (SOFC) having a structure capable of improving current collection efficiency through the electric field concentration effect such as an asymmetric flat tubular SOFC capable of achieving high-efficiency current collection.

Embodiments also provide an SOFC capable of improving current collection efficiency by reducing or minimizing an electron transfer distance.

A second auxiliary extending portion may be further formed from each of both the ends of the second long side to a point at which the end of the second long side vertically approaches the first long side. The current collector may be extended to cover the second auxiliary extending portions.

According to one embodiment of the present invention, a solid oxide fuel cell includes: a first electrode having a first side and a second side substantially parallel to the first side; a plurality of walls partitioning an interior of the first electrode into a plurality of flow channels extending through the first electrode, wherein a first wall of the walls extends from the first side to a center portion of the second side and a second wall of the walls extends from the first side to the center portion of the second side; a current collector adjacent a center portion of the first side or the center portion of the second side; a second electrode partially surrounding the first electrode; and an electrolyte between the first electrode and the second electrode.

The electrolyte may expose the center portion of the second side of the first electrode.

The current collector may contact the center portion of the second side of the first electrode.

The current collector may be insulated from the second electrode.

The first electrode may have third and fourth sides that are opposite to each other, each of the third and fourth sides extending between the first and second sides.

Each of the flow channels may have a triangular cross section in which each of the walls shared by two of the flow channels, the third side, and the fourth side forms an electron path between the first side and the second side.

The flow channels may include a first flow channel, a second flow channel, and a third flow channel.

The first flow channel may have a triangular cross section having a first corner at a first end of the first side, a second corner at a second end of the first side, and a third corner at the center portion of the second side.

Each of the second flow channel and the third flow channel may have a triangular cross section, wherein the second flow channel has a first corner at a first end of the first side, a second corner at a first end of the second side near the first end of the first side, and a third corner at the center portion of the second side, and wherein the third flow channel has a first corner at a second end of the first side, a second corner at a second end of the second side near the second end of the first side, and a third corner at the center portion of the second side.

The first wall may extend from a first end of the first side toward the center portion of the second side and the second wall may extend from a second end of the first side toward the center portion of the second side.

The solid oxide fuel cell may further include another wall extending between a center portion of the first side and the center portion of the second side.

The first side may be shorter than the second side.

The solid oxide fuel cell may further include another wall extending between one end of the first side and the second side in a direction substantially perpendicular to the second side.

The current collector may contact a portion of the second side adjacent to where the another wall contacts the second side.

The first electrode may have a substantially trapezoidal cross section.

In an asymmetric flat tubular fuel cell according to embodiments of the present invention, the current collection area can be increased or maximized through the structure on which an electric field is concentrated. Further, a support with an asymmetric shape is provided, thereby reducing or minimizing an electron transfer distance.

Accordingly, the current collection efficiency can be improved or maximized through the electric field concentration and the reduction or minimization of the electron transfer distance.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic perspective view showing a symmetric flat tubular unit cell according to a comparative example.

FIG. 2 is a cross-sectional view showing an asymmetric flat tubular unit cell according to an embodiment of the present invention.

FIG. 3 is a schematic cross-sectional view illustrating the transfer of electrons in the asymmetric flat tubular unit cell of FIG. 2.

FIG. 4 is a schematic cross-sectional view illustrating the transfer of electrons in the symmetric flat tubular unit cell of FIG. 1 having angled internal paths.

FIG. 5 is a cross-sectional view showing an asymmetric flat tubular unit cell according to another embodiment of the present invention.

FIG. 6 is a cross-sectional view showing an asymmetric flat tubular unit cell according to still another embodiment of the present invention.

FIG. 7 is a cross-sectional view showing an asymmetric flat tubular unit cell according to another embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements. In the drawings, the thickness or size of layers are exaggerated for clarity and not necessarily drawn to scale.

A fuel cell generally includes a fuel processor (a reformer and a reactor) that reforms fuel and supplies the reformed fuel and a fuel cell module. Here, the fuel cell module refers to an assembly including a fuel cell stack that converts chemical energy into electrical energy and thermal energy using an electrochemical method. In one embodiment, the fuel cell module includes a fuel cell stack; a pipe system through which fuel, oxide, cooling water, emission and the like are transferred; a wire through which electricity is produced by the fuel cell stack; a component for controlling or monitoring the fuel cell stack; a component for taking action when an abnormal state of the fuel cell stack occurs; and the like.

One aspect of an embodiment of the present invention relates to a structure of a unit cell, particularly a flat tubular unit cell. Hereinafter, embodiments of the present invention will be described in more detail.

### COMPARATIVE EXAMPLE 1

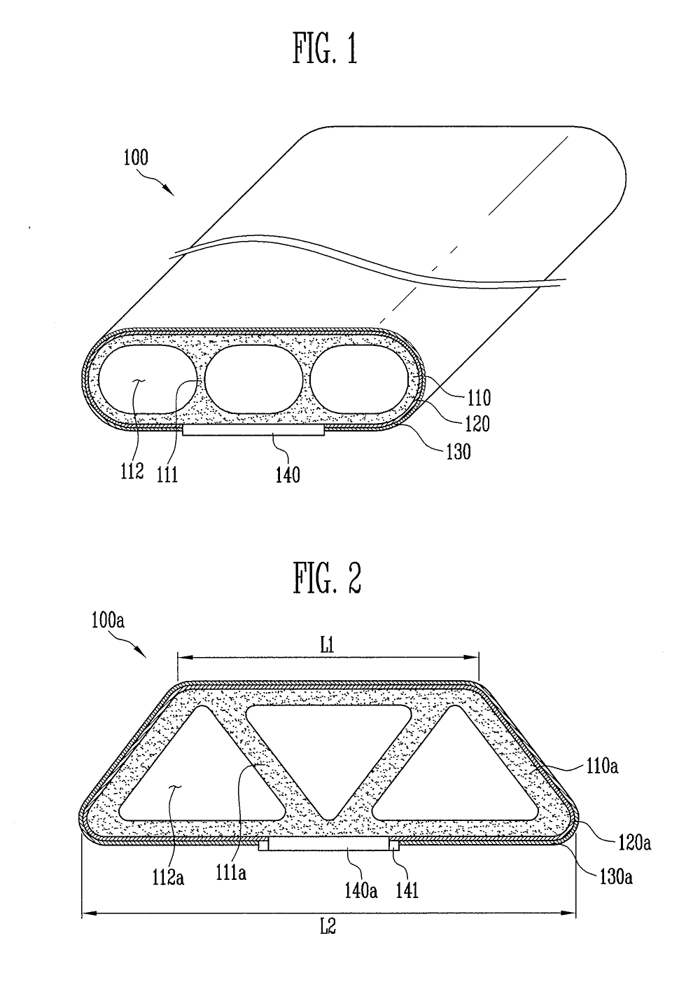

A flat tubular unit cell according to Comparative Example 1 will be described with reference to FIG. 1. FIG. 1 is a schematic perspective view showing a symmetric flat tubular unit cell according to Comparative Example 1.

The flat tubular unit cell 100 according to Comparative Example 1 includes a first electrode support 110, an electrolyte layer 120, a second electrode layer 130 and a current collector 140.

The first electrode support 110 forms a frame of the flat tubular unit cell 100 and maintains the shape of the flat tubular unit cell 100. The first electrode support 110 is formed in the shape of a flat tube. In order to simplify manufacture and to improve structural stability, the first electrode support 110 is generally formed so that its long sides are flat and its short sides have a substantially constant curvature.

The first electrode support 110 serves as a passage (or path) through which electrons are transferred. The interior of the first electrode support 110 is partitioned into two or more spaces, thereby forming a plurality of flow channels 112 extending along the length of the tube. In this embodiment, electron transfer paths provided between the respective flow channels in the interior of the first electrode support 110 are referred to as internal paths 111. As shown in FIG. 1, the internal paths 111 connect two long sides opposite to each other along the length direction (or the length) of the first electrode support 110. Electron transfer paths of the first electrode support 110 other than the internal paths 111 may be referred to as external paths.

The type of the unit cell may be classified into an anode-supported type or a cathode-supported type in accordance with the polarity of the first electrode support. However, embodiments of the present invention are not limited to anode-supported types, cathode-supported types and the like. That is, the first electrode support 110 may be an anode or cathode. When the first electrode support 110 is an anode, the second electrode layer 130, which will be described in more detail later, is a cathode. On the other hand, when the first electrode support 110 is a cathode, the second electrode layer 130 is an anode. For the sake of convenience and without limitation thereto, the type of the unit cell will be described as an anode-supported type, i.e., that the first electrode support 110 is an anode, in each of the following comparative examples and embodiments. However, each of the following comparative examples and embodiments should be considered equally applicable to the cathode-supported type.

The current collector 140 is located along any one of the long sides of the unit cell. The current collector 140 extends along the length direction on an outer surface at a center portion of one of the long sides and contacts the long side including points of the long side at which the respective internal paths 111 are connected. The current collector 140 functions to receive electrons transferred from the first electrode support 110 and to transfer the received electrons to an external circuit or the like.

The electrolyte layer 120 surrounds portions of the first electrode support 110 except the portion at which the current collector 140 contacts the outer circumferential surface of the first electrode support 110. The electrolyte layer 120 provides a transfer path for oxygen and hydrogen ions to flow between the anode electrode and the cathode electrode (e.g., between the first electrode support 110 and the second electrode layer 130).

The second electrode layer 130 surrounds the outer circumferential surface of the electrolyte layer 120. The second electrode layer 130 is insulated from the current collector 140. In order to be insulated from the current collector 140, the second electrode layer 130 may be formed to be spaced part from each other or may provided with an insulator interposed between the second electrode layer 130 and the current collector 140.

During the driving of a fuel cell having the flat tubular unit cell 100, when fuel using hydrogen as a main raw material (e.g., main raw fuel material) is supplied to the flow channels in the interior of the first electrode support 110, electrons are generated by an oxidation reaction. The generated electrons are collected by the first electrode support 110, and the collected electrons are transferred to the current collector 140 along the external paths or internal paths 111 of the first electrode support 110. In order to improve the current collection efficiency of the current collector 140, the magnitude of a voltage drop due to internal resistance can be decreased by decreasing or minimizing an electron transfer distance. Thus, the current collector 140 is located at the outer circumferential surface of the first electrode support 110 through which the internal paths 111 are connected.

### Embodiment 1

An asymmetric flat tubular unit cell 100a according to an embodiment of the present invention will be described with reference to FIGS. 2, 3 and 4. FIG. 2 is a cross-sectional view showing an asymmetric flat tubular unit cell according to an embodiment of the present invention.

The flat tubular fuel cell 100a according to this embodiment includes a first electrode support 110a, an electrolyte layer 120a, a second electrode layer 130a and a current collector 140a.

The first electrode support 110a is formed in the shape of an asymmetric flat tube (e.g., a tube having an substantially trapezoidal cross section). That is, a first long side is formed to have a length of L2, and a second long side opposite to the first long side is formed to have a length of L1 shorter than that of the second long side L2. In this embodiment, both short sides that connect the two long sides are formed to be inclined by (or angled due to) the length difference between the two long sides. In this embodiment, the short sides may be formed to be flat surfaces. Like the comparative example, internal paths 111a are formed in the interior of the first electrode support 110a. Here, the internal path 111a extends between adjacent flow channels 112a or connects a center portion of the first long side to each of the ends of the second long side. As shown in the embodiment of FIG. 2, the first electrode support 110a is partitioned into three substantially triangular flow channels 112a that share sides with one another by the internal paths 111a.

Meanwhile, the center portion of the first long side, at which the internal paths 111a are connected, is referred to as an electric field concentration portion (P0 of FIG. 3). The current collector 140a contacts the electric field concentration portion. As described above, the current collector 140a receives electrons transferred from the first electrode support 110a and transfers the received electrons to an external circuit or the like.

The electrolyte layer 120a surrounds the outer circumferential surface of the first electrode support 110a except the portion at which the current collector 140a is located. As described above, the electrolyte layer 120a serves as a transfer path of oxygen and hydrogen ions.

The second electrode layer 130a surrounds the outer circumferential surface of the electrolyte layer 120a. The second electrode layer 130a is insulated from the current collector 140a. In order to be insulated from the current collector 140a, the second electrode layer 130a may be spaced apart from the current collector 140a or may provided with an insulating material 141 (shown in FIG. 2) interposed between the second electrode layer 130a and the current collector 140a.

The cathode may be formed of a pure electron conductor or mixed conductor such as a LaMnO₃-based or LaCoO₃-based material, which has high ion and electron conductivity, stability under an oxygen atmosphere, and substantially no chemical reaction with the electrolytic layer which will be described later. The electrolytic layer serves as a path along (or through) which oxygen ions produced in the cathode and hydrogen ions produced in the anode (which will be described in more detail) can flow. The electrolytic layer may be made of a ceramic material of sufficient compactness such that gas does not penetrate the ceramic material. For example, yttria stabilized zirconia (hereinafter, referred to as “YSZ”) obtained by adding a small amount of Y₂O₃ to ZrO₂ may be used as the electrolytic layer. The YSZ is formed into a structure having high ion conductivity under oxidation and reduction atmospheres and chemical and physical stability. The anode is a portion to which hydrogen gas that is fuel of the fuel cell is supplied. The anode may be made of a ceramic material such as YSZ. For example, a metal ceramic complex (which may be referred to as a “cermet”) such as NiO-8YSZ or Ni-8YSZ may be used as the anode. A metal ceramic complex (cermet) generally has a low price and stability under a high-temperature reduction atmosphere.

The internal path 111a may be formed of another material having properties similar to those of the material used to form the first electrode support 110a or may be formed of the same material as that of the first electrode support 110a. For the sake of convenience and without limitation thereto, the internal path 111a will be described below as being formed of the same material as the first electrode support 110a

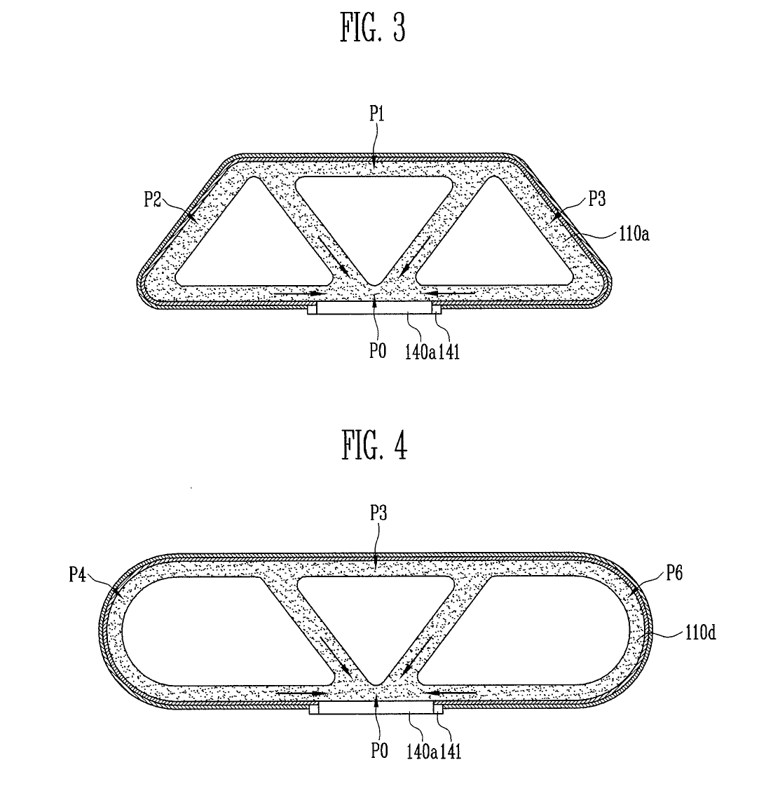

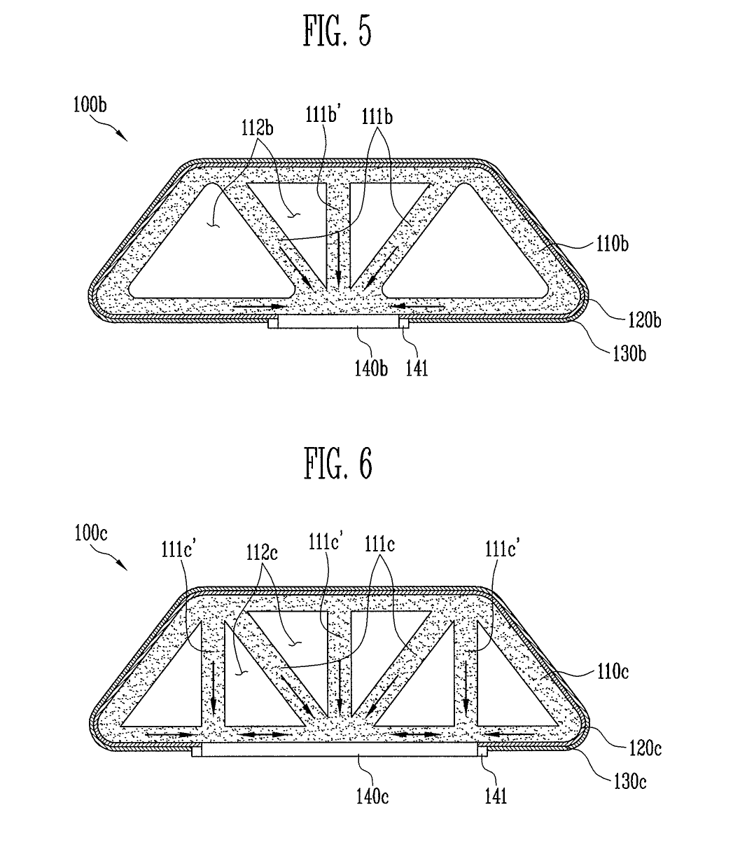

The operation of Embodiment 1 will be described with reference to FIGS. 2, 3, and 4. FIG. 3 is a schematic cross-sectional view illustrating the transfer of electrons in the asymmetric flat tubular unit cell 100a of the embodiment illustrated in FIG. 2. FIG. 4 is a schematic cross-sectional view illustrating the transfer of electrons in a symmetric flat tubular unit cell according to Comparative Example 2.

During the driving of a fuel cell having the asymmetric flat tubular unit cell 100a, when fuel using hydrogen as a main raw material (e.g., main raw fuel material) is supplied to the flow channels 112a in the interior of the first electrode support 110a, electrons are generated by an oxidation reaction. The generated electrons are collected by the first electrode support 110a, and the collected electrons are transferred to the current collector 140a along the external paths or internal paths 111a of the first electrode support 110. In this embodiment, the electrons are concentrated at the electric field concentration portion P0 as shown in FIG. 3. The width of the current collector 140a contacting the electric field concentration portion P0 can be shorter than that of the current collector 140 of Comparative Example 1. Because the current collector 140a is shorter, the surface area of the second electrode layer 130a can be increased in comparison to the second electrode layer 130 of Comparative Example 1. When the surface area of the second electrode layer 130a is increased, the surface area of the fuel cell, which participates in the chemical reaction, is increased. Accordingly, generation efficiency is increased, and thus the amount of current that can be generated is increased.

The electric field concentration portion P0 has the following features. Firstly, it is possible to achieve effective current collection with a smaller surface area of the current collector 140a. Secondly, because the surface area of the current collector 140a that occupies the outer circumferential surface of the asymmetric flat tubular unit cell 100a is decreased, the generation efficiency of the asymmetric flat tubular unit cell 100a can be improved because the surface area of the second electrode layer 130a is increased.

A symmetric unit cell (Comparative Example 2) in which the lengths of both long sides are the same as shown in FIG. 4 illustrates a maximum electron transfer distance. The maximum electron transfer distance of the asymmetric flat tubular unit cell 100a illustrated in FIG. 3 is the distance from point P1, P2 or P3 to the electric field concentration portion P0 along the external paths of the first electrode support 110a. On the other hand, in the symmetric flat tubular unit cell of Comparative Example 2, the maximum electron transfer distance is the distance from point P4 or P6 to the electric field concentration portion P0 along the external paths of the first electrode support 110d. That is, the maximum electron transfer distance of the asymmetric flat tubular unit cell 110a illustrated in FIG. 3 is shorter than that of the symmetric flat tubular unit cell shown in FIG. 4. Therefore, the maximum electron transfer distance of the asymmetric flat tubular unit cell is shorter than that of the symmetric flat tubular unit cell, and consequently, the magnitude of a voltage drop due to internal resistance is smaller in the embodiment of FIG. 3 than in Comparative Example 2.

The unit cells of Comparative Example 1 and Embodiment 1 are designed to output the same power per unit reaction area, and experiments were performed on the unit cells built in accordance with Comparative Example 1 and Embodiment 1. As a result, an output current of 0.165 A was produced by the unit cell of Comparative Example 1, and an output current of 0.225 A was produced by the unit cell of Embodiment 1. That is, it can be seen that the efficiency of the fuel cell in Embodiment 1 is increased by 45.5% compared with that of Comparative Example 1.

### Embodiment 2

An asymmetric flat tubular unit cell 100b according to another embodiment of the present invention will be described with reference to FIG. 5. FIG. 5 is a cross-sectional view showing the asymmetric flat tubular unit cell 100b according to one embodiment of the present invention.

The asymmetric flat tubular unit cell 100b of Embodiment 2 is different from the asymmetric flat tubular unit cell 100a of Embodiment 1 in the number of internal paths 111b and 111b′ and the position of an additional internal path 111b′.

That is, two internal paths 111b connect the respective ends of the second long side to a center portion of the first long side in the interior of a first electrode support 110b. An additional internal path 111b′ is formed from the center of the second long side to the center portion of the first long side, to which the internal paths 111b are connected. As shown in FIG. 5, flow channels 112b having a form in which a central flow channel is divided into two flow channels (e.g., a left flow channel and a right flow channel) are formed in the interior of the first electrode support 110b, and thus a total of four flow channels 112b are formed in the interior of the first electrode support 110b.

In this embodiment, a total of five electron transfer paths are concentrated on a portion of the first electrode support 110b that comes in contact with a current collector 140b. Here, the five electron transfer paths include a total of three internal paths 111b and 111b′ and the external paths of the first electrode support 110b. This means that one internal path 111b′ is added as compared with Embodiment 1 shown in FIG. 2. Accordingly, it is possible to improve the electric field concentration effect. That is, as the number of paths is increased, it is possible to reinforce the electric field concentration effect according to the increase in electron transfer path. Further, as the surface area of the interior of the first electrode support 110b is increased accordingly, so that it is possible to further improve the current collection efficiency.

### Embodiment 3

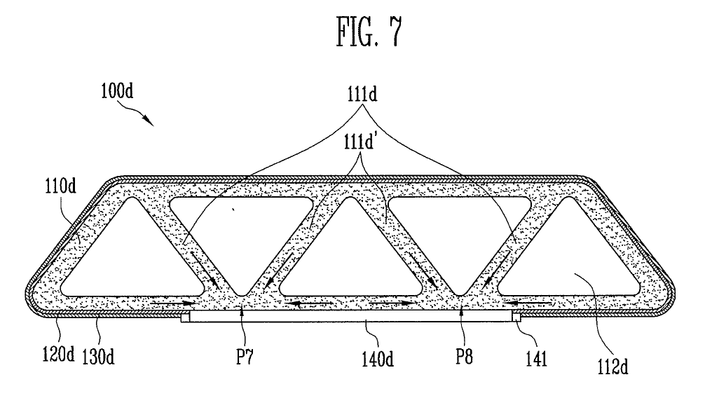

An asymmetric flat tubular unit cell 100c according to Embodiment 3 will be described with reference to FIG. 6. FIG. 6 is a cross-sectional view showing the asymmetric flat tubular unit cell 100c according to Embodiment 3.

The asymmetric flat tubular unit cell 100c of Embodiment 3 is different from the asymmetric flat tubular unit cell 100b of Embodiment 2 in the number of internal paths 111c, 111c′, and 111c″ and the positions of the internal paths 111c, 111c′, and 111c″.

Two internal paths 111c that connect the respective ends of the second long side to a center portion of the first long side are formed in the interior of a first electrode support 110c. An internal path 111c″ that connects the center of the second long side to the center portion of the first long side, to which the internal paths 111c are connected, is further formed in interior of the first electrode support 110c. Additional internal paths 111c′ that connect from each of both the ends of the second long side to a respective point of the first long side, such that the additional internal paths 111c′ extend in a direction substantially perpendicular to the first long side, are further formed in interior of the first electrode support 110c.

As shown in FIG. 6, flow channels having a form in which each of the three flow channels 112a of Embodiment 1 is divided into two flow channels are formed in the interior of the first electrode support 110c, and thus a total of six flow channels are formed in the interior of the first electrode support 110c. The six flow channels 112c are provided adjacent to each other while sharing a respective one of the internal paths 111c, 111c′, and 111c″ as a side.

Meanwhile, in Embodiment 3, the two additional internal paths 111c′ are connected to portions other than the electric field concentration portion (e.g., other than the center portion of the first long side). In this case, a current collector 140c may be provided to come in contact with only the electric field concentration portion P0 as described in Embodiments 1 and 2. However, in order to achieve more effective current collection, the current collector 140c may be extended to the points at which the additional internal paths 111c′ are connected to the first long side, as shown in the embodiment of FIG. 6.

In a case where the width of the current collector 140c is extended, the surface area of the second electrode layer that participates in the chemical reaction is decreased as described in Comparative Example 1. Therefore, the entire amount of current generated by the chemical reaction is decreased, and consequently, the current collection efficiency may be reduced.

However the asymmetric flat tubular unit cell 100c of Embodiment 3 is significant when it is used in a fuel cell for high-power large current. That is, when a larger amount of current is collected through the current collector 140c as compared with a medium- or small-sized unit cell, it may be advantageous for the width of the current collector 140c to be increased so as to achieve more stable current collection.

In this case, the electric field concentration effect still exists at the center portion of the second long side, and it is still possible to obtain the effect that the electron transfer distance is reduced by the length difference between the two long sides opposite to each other.

### Embodiment 4

An asymmetric flat tubular cell 100d according to Embodiment 4 will be described with reference to FIG. 7. FIG. 7 is a cross-sectional view showing the asymmetric flat tubular cell 100d according to Embodiment 4.

The asymmetric flat tubular unit cell 100d of Embodiment 4 is different from the asymmetric flat tubular cells 100a, 100b, and 100c of Embodiments 1, 2, and 3 in the number of internal paths 111d and 111d′ and the positions of the internal paths 111d and 111d′. In addition, the lengths of the long sides (e.g., in comparison to the lengths of the short sides) may be longer than the lengths of the long sides in Embodiments 1, 2, and 3.

In Embodiment 4, four internal paths 111d and 111d′ are formed within the first electrode support 100d. Two internal paths 111d connect the respective ends of the second long side to first (P1) and second (P2) portions, respectively, of the first long side. In addition, two internal paths 111d′ connect the central portion of the second long side to the first (P1) and second (P2) portions of the first long side, respectively.

As shown in FIG. 7, flow channels having a form in which five flow channels 112d similar to the flow channels 112a of Embodiment 1 are formed in the interior of the first electrode support 110d. The five flow channels are provided adjacent to each other while sharing a respective one of the internal paths 111d or 111d′ as a side.

The current collector 140d is provided to be in contact with both the first and second portions of the first long side. The current collector may be electrically insulated from the second electrode layer 130d by insulating material 141.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A solid oxide fuel cell comprising:
a first electrode having a first side and a second side substantially parallel to the first side;
a plurality of walls partitioning an interior of the first electrode into a plurality of flow channels extending through the first electrode, wherein a first wall of the walls extends from the first side to a center portion of the second side and a second wall of the walls extends from the first side to the center portion of the second side;
a current collector adjacent a center portion of the first side or the center portion of the second side;
a second electrode partially surrounding the first electrode; and
an electrolyte between the first electrode and the second electrode.

2. The solid oxide fuel cell of claim 1, wherein the electrolyte exposes the center portion of the second side of the first electrode.

3. The solid oxide fuel cell of claim 1, wherein the current collector contacts the center portion of the second side of the first electrode.

4. The solid oxide fuel cell of claim 1, wherein the current collector is insulated from the second electrode.

5. The solid oxide fuel cell of claim 1, wherein the first electrode has third and fourth sides that are opposite to each other, each of the third and fourth sides extending between the first and second sides.

6. The solid oxide fuel cell of claim 5, wherein each of the flow channels has a triangular cross section in which each of the walls shared by two of the flow channels, the third side, and the fourth side forms an electron path between the first side and the second side.

7. The solid oxide fuel cell of claim 1, wherein the flow channels comprise a first flow channel, a second flow channel, and a third flow channel.

8. The solid oxide fuel cell of claim 7, wherein the first flow channel has a triangular cross section having a first corner at a first end of the first side, a second corner at a second end of the first side, and a third corner at the center portion of the second side.

9. The solid oxide fuel cell of claim 7, wherein each of the second flow channel and the third flow channel has a triangular cross section,
wherein the second flow channel has a first corner at a first end of the first side, a second corner at a first end of the second side near the first end of the first side, and a third corner at the center portion of the second side, and
wherein the third flow channel has a first corner at a second end of the first side, a second corner at a second end of the second side near the second end of the first side, and a third corner at the center portion of the second side.

10. The solid oxide fuel cell of claim 1, wherein the first wall extends from a first end of the first side toward the center portion of the second side and
wherein the second wall extends from a second end of the first side toward the center portion of the second side.

11. The solid oxide fuel cell of claim 1, further comprising another wall extending between a center portion of the first side and the center portion of the second side.

12. The solid oxide fuel cell of claim 1, wherein the first side is shorter than the second side.

13. The solid oxide fuel cell of claim 12, further comprising another wall extending between one end of the first side and the second side in a direction substantially perpendicular to the second side.

14. The solid oxide fuel cell of claim 13, wherein the current collector contacts a portion of the second side adjacent to where the another wall contacts the second side.

15. The solid oxide fuel cell of claim 12, wherein the first electrode has a substantially trapezoidal cross section.
